(19) United States
(12) Patent Application Publication
(10) Pub. No.: US 2026/0036475 A1
(43) Pub. Date: Feb. 5, 2026

(54) DEVICE FOR MEASURING A FORCE AND/OR TORQUE

(71) Applicant: Neura Robotics GmbH, Metzingen (DE)

(72) Inventor: Eamon BARRETT, Reutlingen (DE)

(21) Appl. No.: 19/284,164

(22) Filed: Jul. 29, 2025

(30) Foreign Application Priority Data
Aug. 1, 2024 (DE) 102024122003.1

(51) Int. Cl. G01L 1/24; G01K 1/02; G01L 3/08

(52) U.S. Cl. CPC G01L 1/24; G01K 1/026; G01L 3/08

(57) ABSTRACT

A device measures a force and/or torque with a deformation body. The device includes a first fastening element, a second fastening element arranged spaced apart in a direction from the first fastening element and at least one length element arranged between the two fastening elements. The device has and comprising a first end, a second end and a length along a longitudinal direction. A force acting on the deformation body or a torque acting on the deformation body leads to a deformation of the length element. An input-side input of a mechanical amplifier is fastened to the deformation body by means of a coupling element. A material measure is arranged on an output-side output of the mechanical amplifier and a deformation of the length element leads to a movement of the material measure. The movement of the material measure can be detected by a scanning element.

The invention relates to a device for measuring a force and/or torque according to the preamble of claim 1.

In automation technology, 6-axis force-torque sensors are often used to determine the forces and torques acting in all directions. For example, such sensors may be used in the automatic joining or assembly of workpieces, in deburring, polishing or grinding, in haptic measurements or other applications. Said sensors measure the forces (F or Fx, Fy, Fz) and torques (M or Mx, My, Mz) acting on them in and about three coordinates (x, y, z). On the one hand, such sensors need to be designed to be as rigid as possible so that they themselves do not experience any deformation due to the forces or torques. On the other hand, the highest possible resolution of the measured signals needs to be achieved, which is usually not possible with rigid measuring systems, which only experience small deformations due to their rigidity. Known sensors use, for example, strain gauges, which can measure very small material strains to determine forces and torques. However, applying strain gauges is very complex. In addition, strain gauges require high signal amplification, which leads to high costs for such 6-axis force-torque sensors. If strain gauges are overloaded, the entire 6-axis force-torque sensor must be replaced, which also causes high costs.

DE 10 2019 135 732 A1 discloses a device for measuring a change in length comprising a first fastening element, a second fastening element and at least one length element arranged between the two fastening elements and comprising a first end, a second end and a length along a longitudinal direction, wherein a force acting parallel to the longitudinal direction leads to a change in the length of the length element, is characterized in that a lever element comprising a first end, a second end and a fulcrum is arranged transverse to the longitudinal direction, wherein the lever element has a first lever arm comprising a first length between the fulcrum and a first lever arm end and a second lever arm comprising a second length between the fulcrum and a second lever arm end, wherein the second length is greater than the first length, in that the first end of the length element is pivotably arranged on the first lever arm end of the first lever arm and wherein the second lever arm end of the second lever arm is connected to a material measure whose movement can be detected by a scanning element. said device also has the disadvantage that in case of overload the entire device must be replaced.

The object of the invention is therefore to provide an improved device for measuring a force and/or torque, in particular, for use in 6-axis force-torque sensors, which, in particular, does not have to be completely replaced in the event of overload.

The object is achieved according to the invention by a device for measuring a force and/or torque having the features of claim 1.

Advantageous embodiments and developments of the invention are specified in the dependent claims.

The inventive device for measuring a force and/or torque with a deformation body that comprises a first fastening element, a second fastening element arranged spaced apart in one direction from the first fastening element and at least one length element arranged between the two fastening elements and comprising a first end, a second end and a length along a longitudinal direction, wherein a force acting on the deformation body or a torque acting on the deformation body leads to a deformation of the length element, is characterized in that an input-side input of a mechanical amplifier is fastened to the deformation body by means of a coupling element, wherein a material measure is arranged on an output-side output of the mechanical amplifier and a deformation of the length element leads to a movement of the material measure, wherein the movement of the material measure can be detected by a scanning element, wherein the device comprises an evaluation unit which is designed to evaluate the signals detected by the at least one scanning element and to calculate therefrom the forces and/torques acting between the two fastening elements.

The invention is based on the idea that a complete replacement of a device damaged by overload can be avoided if the deformation body, which absorbs the acting force or the acting torque, is separated by a coupling element from the components that measure the deformation, in particular the mechanical amplifier, which at least partially absorbs the deformation of the deformation body and amplifies it for detection by a scanning element. This can reduce or avoid the effect that the components involved in the deformation measurement themselves undergo deformation. Wear and failure of individual components can be minimized by modularizing the device 1.

The coupling element makes it possible, in particular, to pick up only a portion of the force acting on the deformation body and/or the torque acting on the deformation body, in particular substantially transverse to the direction, and to transmit it to the mechanical amplifier. This allows the mechanical amplifier to be reliably protected against overload.

The coupling element is preferably detachably fastenable, in particular, to the deformation body and/or to the mechanical amplifier. Such a design makes it possible, in the event of damage to the deformation body due to overload, to detach the mechanical amplifier from the deformation body and attach it to a new deformation body, so that replacement of defective components is possible and complete replacement of the device can be avoided.

Advantageously, the coupling element is designed as a screw, a clampable pin, a glued pin or an adhesive. Such coupling elements can be manufactured, assembled and replaced easily and cost-effectively.

According to a particularly preferred embodiment of the invention, the mechanical amplifier is designed as a flexure mechanism. A flexure mechanism is understood to be a single component that is particularly flexible at certain points, allowing movement to be carried out even though there are no conventional joints. The flexible points are called flexure hinges.

The flexure mechanism is preferably formed in one piece and has at least one flexure hinge, preferably a plurality of flexure hinges. The flexible points can be realized, for example, by recesses in the material.

Advantageously, the flexure mechanism is made of metal, preferably aluminum or steel.

The first fastening element is preferably disc-like or disc-ring-like comprising a first plane and the second fastening element is disc-like or disc-ring-like comprising a second plane, wherein the first plane and the second plane are arranged parallel to one another. The disc-like design of the fastening elements enables good fastening to the components that are to be moved relative to one another and between which the forces and torques occurring are to be measured.

According to an advantageous embodiment of the invention, the longitudinal direction of the length element is arranged at an angle between 5° and 85° relative to the direction Z, preferably at an angle between 10° and 80°, preferably at an angle of 20° to 50°, particularly preferably at an angle of approximately 35°. By using such a length element arranged at an angle relative to the fastening elements, the rigidity of the deformation body can be increased, wherein forces and/or torques can be absorbed better than using a length element arranged perpendicular to the fastening elements.

A particularly preferred embodiment provides that a plurality of length elements, in particular at least six length elements, for example exactly six length elements, are arranged between the first fastening element and the second fastening element. This enables the forces and torques acting between the two fastening elements in and about three axes to be determined and thus the design as a 6-axis force-torque sensor.

Advantageously, the deformation body is rotationally symmetrical with a rotation angle of 120°. A symmetrical design promotes high signal quality of the device.

Particularly preferably, two length elements are arranged between the first fastening element and the second fastening element, wherein each length element is associated with a mechanical amplifier, wherein the total of two mechanical amplifiers are realized by a single flexure mechanism that has two input-side inputs and two output-side outputs. The association is achieved, in particular, through spatial proximity. The use of a single flexure mechanism that realizes two mechanical amplifiers can increase the accuracy of the device.

According to a particularly advantageous embodiment of the invention, the two length elements are arranged mirror-symmetrically to an axis which is arranged, in particular, perpendicular to the planes of the fastening elements, wherein the flexure mechanism, which comprises the two mechanical amplifiers for said two length elements, is designed mirror-symmetrical. Such a flexure mechanism enables sensitive displacements of the output-side outputs, but at the same time virtually no parasitic movements along and around other spatial axes occur, thus counteracting dependencies between the variables to be determined, in particular, the forces and/or torques in the different spatial directions.

Particularly preferably, the two length elements and the one flexure mechanism form a group, wherein three such groups are arranged between the first fastening element and the second fastening element, wherein the three groups are, in particular, each arranged at an angular distance of 120° from one another. The use of three such groups and thus the use of six length elements and six mechanical amplifiers enables the determination of the forces and torques acting between the two fastening elements in and about three axes and thus the design as a 6-axis force-torque sensor with as few dependencies as possible between the variables to be determined, in particular, the forces and/or torques in the different spatial directions. On the one hand, the symmetrical design can be manufactured in a simple manner, but on the other hand it also simplifies the evaluation of the detected signals.

The scanning element and the evaluation electronics are preferably arranged on a printed circuit board that is arranged in a recess of the first fastening element, in particular, substantially parallel to the plane of the first fastening element. On the one hand, such an arrangement can enable a compact design. On the other hand, in the event the deformation body is overloaded, which manifests itself, for example, in an irreversible deformation, the printed circuit board, as long as it is not also affected, can be removed from the deformation body and inserted into a new deformation body.

Advantageously, the scanning element is designed as an optical, capacitive, inductive or magnetic scanning sensor. Optical sensors, in particular, are particularly robust and enable high-resolution scanning.

Devices for measuring a force and/or a torque that are based on the measurement of a deformation or change in length of a length element are subject to strong influences by temperature changes, for example, when the material of the length element expands at higher temperatures. Advantageously, the device has at least one temperature sensor, preferably at least three temperature sensors, particularly preferably six or eight temperature sensors, in order to be able to take a temperature change into account when measuring the force and/or torque. The use of a plurality of temperature sensors, if said temperature sensors are distributed across the device, enables a more accurate determination of the temperature, for example, by averaging the temperatures measured with the plurality of temperature sensors. The evaluation unit is preferably designed to carry out a correction of the forces and/or torques acting between the two fastening elements with regard to the temperature.

The invention is explained in detail with reference to the following Figures. In the figures:

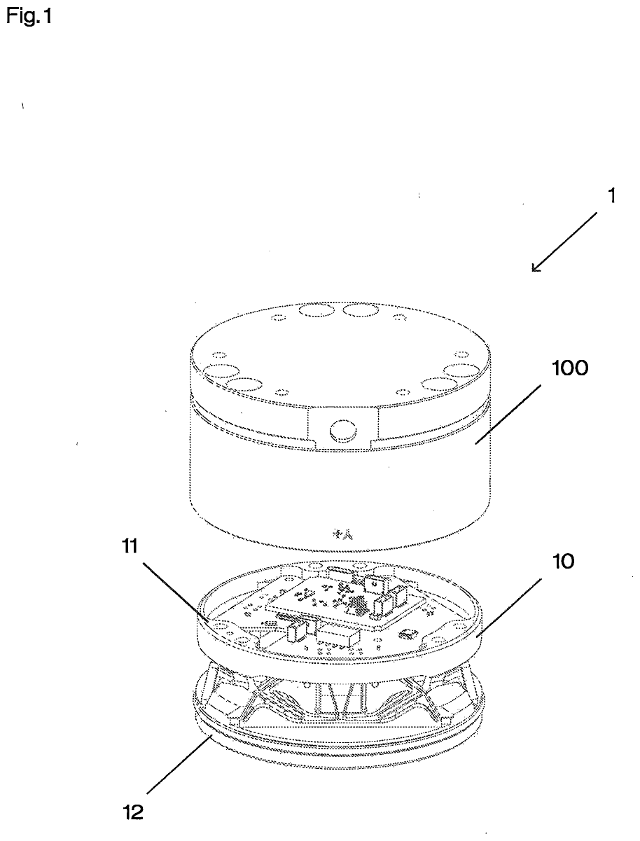

FIG. 1 is a perspective view of an exemplary embodiment of an inventive device for measuring a force and/or torque comprising a housing, a deformation body, three flexure mechanisms and an inserted printed circuit board, the housing being lifted off;

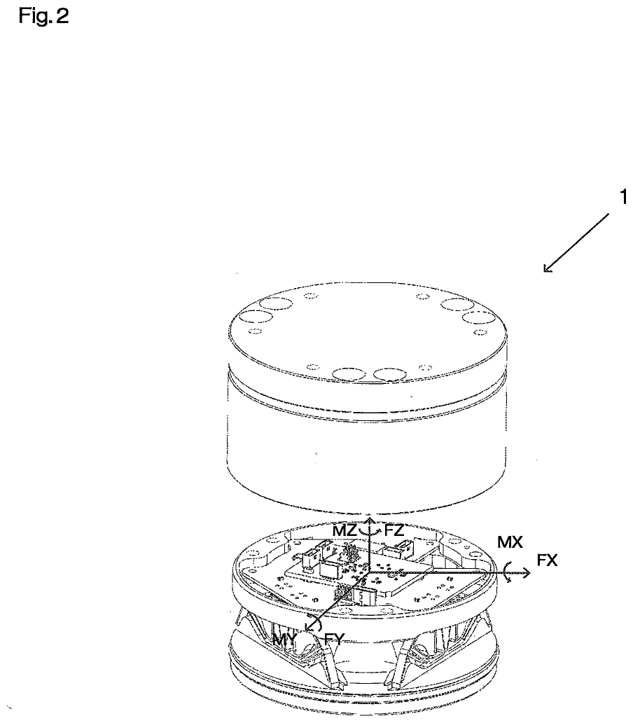

FIG. 2 is a further perspective view of the device according to FIG. 1;

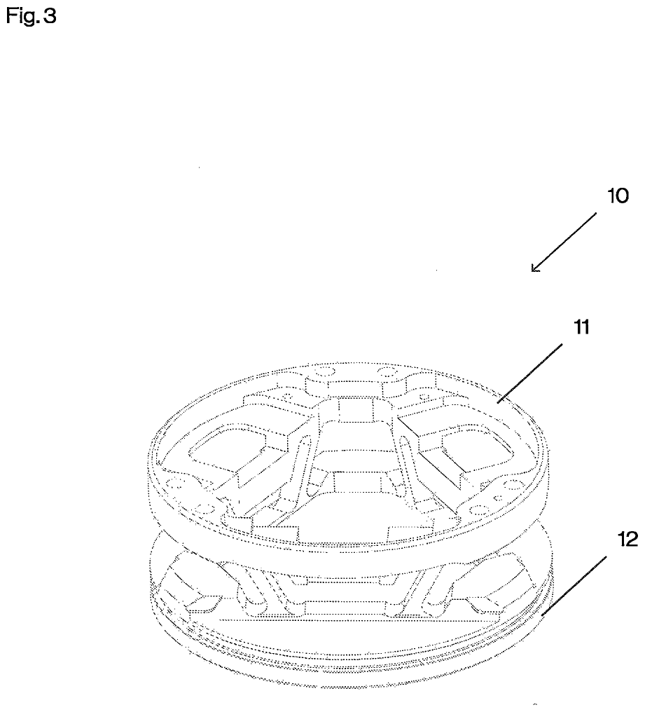

FIG. 3 is a perspective view of the deformation body of the device according to FIG. 1;

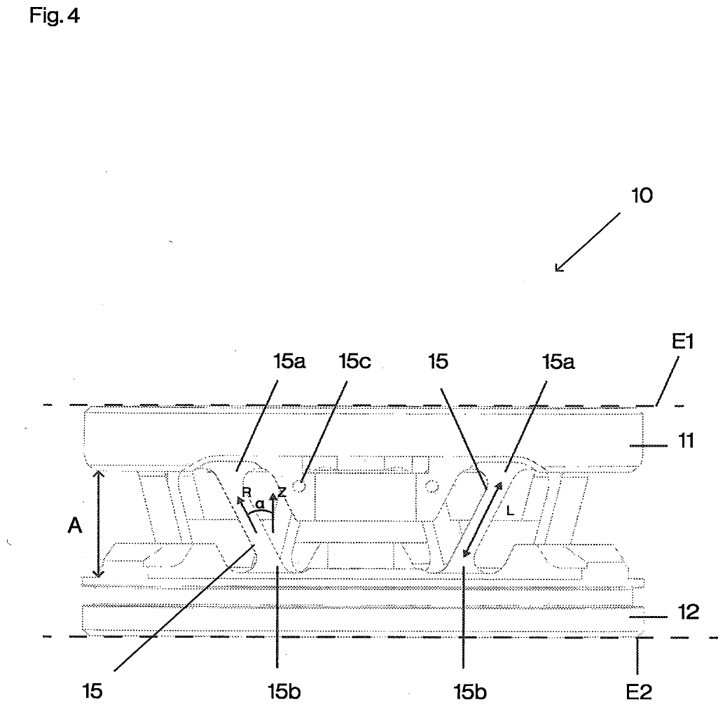

FIG. 4 is a side view of the deformation body according to FIG. 3;

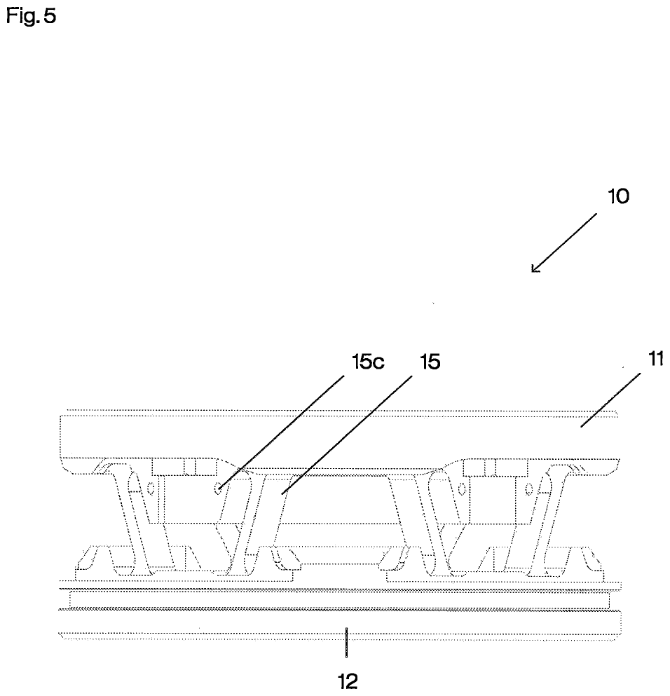

FIG. 5 is a further side view of the deformation body according to FIG. 3;

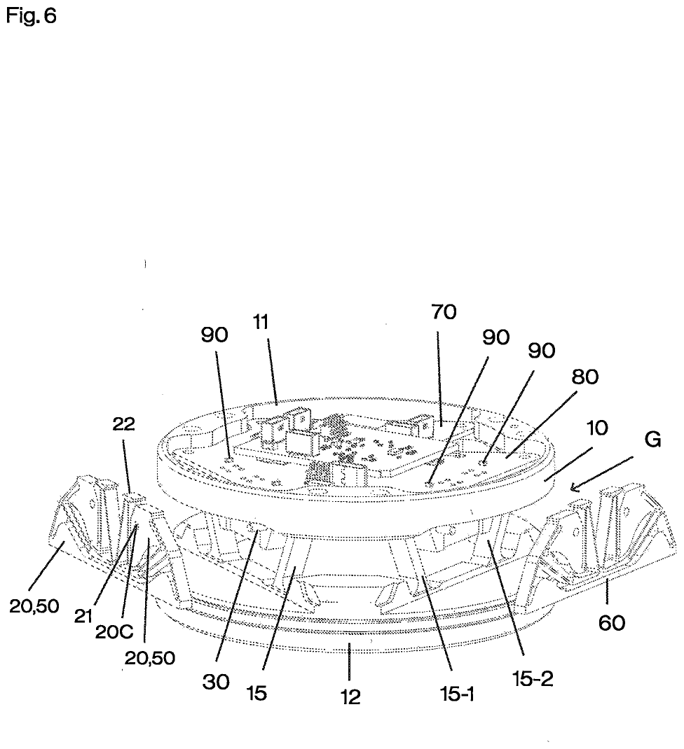

FIG. 6 is a perspective view of the device according to FIG. 1 without housing and with two flexure mechanisms removed laterally;

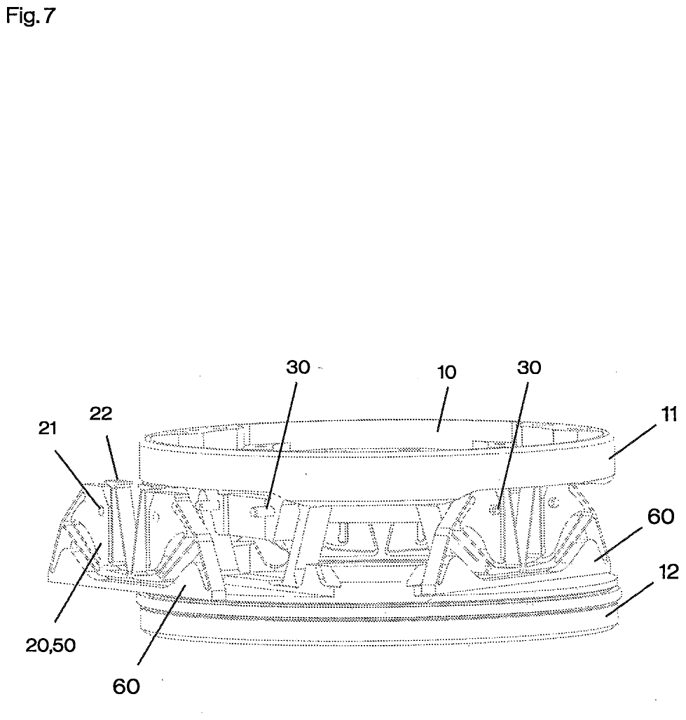

FIG. 7 is a perspective view of the device according to FIG. 1 without housing and with one flexure mechanism removed laterally and one fixed flexure mechanism;

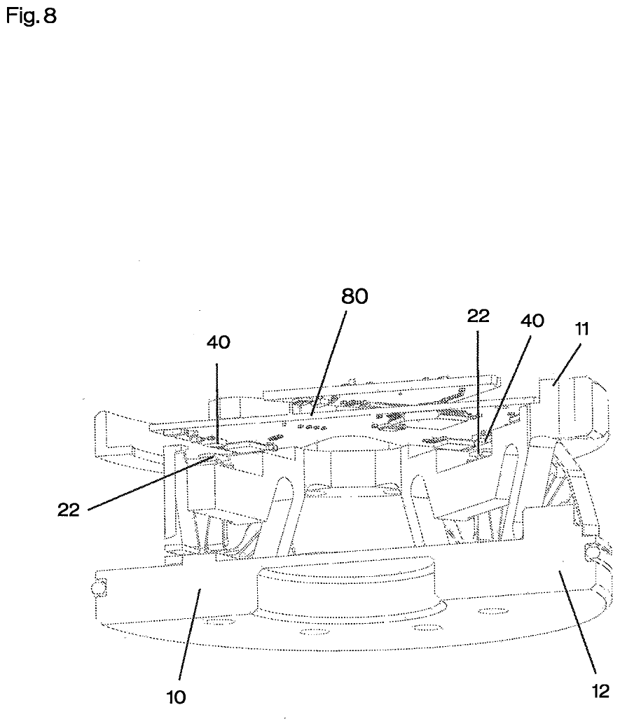

FIG. 8 is a partial sectional perspective view of the deformation body of the device according to FIG. 1 with the printed circuit board, looking at the printed circuit board obliquely from below;

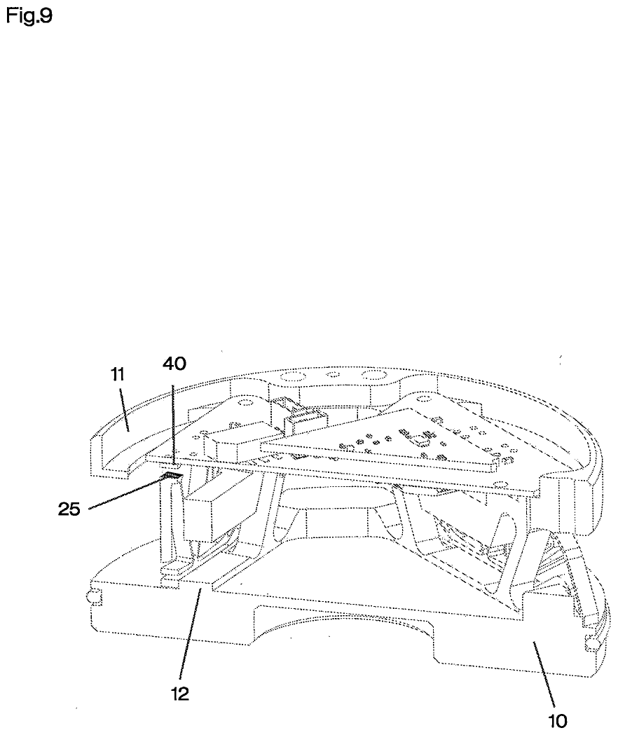

FIG. 9 is a partial sectional perspective view of the deformation body of the device according to FIG. 1 with the circuit board, looking at the printed circuit board obliquely from above;

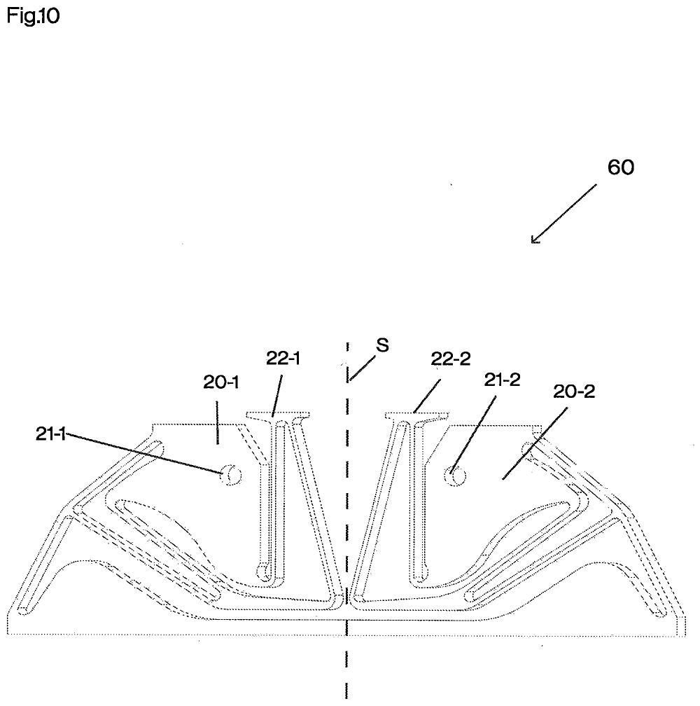

FIG. 10 is a side view of one of the flexure mechanisms of the device according to FIG. 1; and

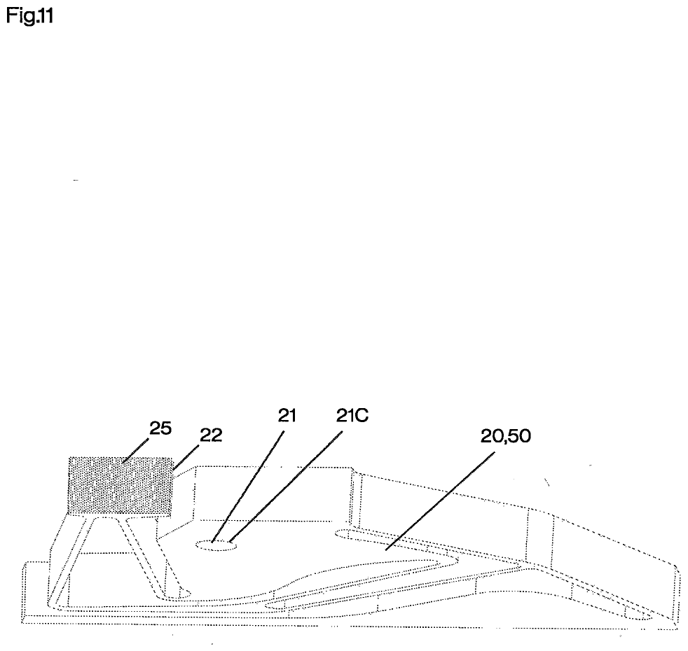

FIG. 11 is a perspective view of the flexure mechanism according to FIG. 10, looking towards an output-side output.

FIGS. 1 to 11 show various views of a first exemplary embodiment of an inventive device 1 for measuring a force F and/or torque M as well as components of said device 1. Identical reference numbers denote identical or functionally identical parts, although for the sake of clarity not all reference numbers are shown in all figures.

The device 1 comprises a deformation body 10, which is shown separately in FIGS. 3 to 5. The deformation body 10 has a first fastening element 11 and a second fastening element arranged in a direction Z at a distance A from the first fastening element 11. The first fastening element 11 may be designed disc-like or disc-ring-like with a first plane El and the second fastening element 12 may be designed disc-like or disc-ring-like with a second plane E2, wherein the first plane El and the second plane E2 are arranged parallel to one another.

At least one length element 15 comprising a first end 15a, a second end 15b and a length L along a longitudinal direction R is arranged between the two fastening elements 11, 12. The first end 15a is, in particular, arranged on the first fastening element 11, while the second end 15b is arranged on the second fastening element 12. Each length element 15 has, in particular, its own longitudinal direction R. This means, in particular, that if there is a plurality of length elements 15, the length elements 15 do not necessarily have to be aligned parallel to one another. The longitudinal direction R of the length element 15 may be arranged at an angle α between 5° and 85° relative to the direction Z, preferably at an angle α between 10° and 80°, preferably at an angle α of 20° to 50°, particularly preferably at an angle α of about 35°.

Preferably, a plurality of length elements, in the present embodiment six length elements 15, is arranged between the first fastening element 11 and the second fastening element 12.

The deformation body 10 may, in particular, be rotationally symmetrical with a rotation angle of 120°.

The device 1 has at least one mechanical amplifier 20, which has an input-side input 21 and an output-side output 22. The input-side input 21 is arranged on the deformation body 10, preferably in the vicinity of the length element 15 or even on the length element 15 itself by means of a coupling element 30, while a material measure 25 is arranged on the output-side output 22.

The coupling element 30 may be detachably fastened either to the deformation body 10 or to the mechanical amplifier 20 or to both the deformation body 10 and the mechanical amplifier 20. The coupling element 30 may be designed as a screw, a clampable pin, a glued pin or an adhesive. In the present exemplary embodiment, the coupling element 30 is designed as a pin which, at one end, is inserted into a bore 15c in the deformation element 10 and which bore is arranged, in particular, transverse to the direction Z of the deformation element 10 and may be arranged, for example, on an axial projection 11c of the first fastening element 11, and, at the other, end is inserted into a bore 20c which is arranged in the mechanical amplifier 20 and there forms, in particular, the input-side input 21. The pin may be clamped, glued or even screwed, if the bores 15c, 20c have a corresponding inner thread, into the two bores 15c, 20c.

The mechanical amplifier 20 is designed, in particular, as a flexure mechanism 50. The flexure mechanism 50 is formed in one piece and has at least one flexure hinge, preferably a plurality of flexure hinges. The flexure hinges may be formed by corresponding recesses in the material. The flexure mechanism 50 is made, in particular, of metal, for example aluminum or steel.

The input-side input 21 may also be formed in the flexure mechanism 50 by the bore 20c into which the coupling element 30 engages. The output-side output 22 has the material measure, which may be arranged, for example, on a flat plate-like segment. The flexure mechanism 50 is arranged on the deformation body 10, in particular, such that it is arranged between the first fastening element 11 and the second fastening element 12, wherein the output-side output 21, in particular the material measure 25, points in the direction of the first fastening element 11.

As already explained, a plurality of length elements, in the present exemplary embodiment six length elements 15, may be arranged between the first fastening element 11 and the second fastening element 12. Furthermore, a plurality of mechanical amplifiers, in the present exemplary embodiment six mechanical amplifiers 20, may be arranged between the first fastening element 11 and the second fastening element 12. Each of the length elements 15 is associated with a mechanical amplifier 20, which can be achieved, in particular, by spatial proximity.

In the present exemplary embodiment, two mechanical amplifiers 20, which are designated 20-1 and 20-2 in FIG. 10 for differentiation purposes, are realized using a single flexure mechanism 60, which accordingly has two input-side inputs 21-1, 21-2 and two output-side outputs 22-1, 22-2. The flexure mechanism 60 is, in particular, designed to be mirror-symmetrical to an axis S, wherein, in particular, one half forms the mechanical amplifier 20-1 and the other half forms the mechanical amplifier 20-2. Likewise, the two associated length elements 15, which for illustration purposes are designated 15-1 and 15-2 in FIG. 6, are arranged mirror-symmetrical to the axis S, which, when the flexure mechanism 60 is attached to the deformation body 10, is arranged, in particular, perpendicular to the planes E1 and D2. The two length elements 15-1, 15-2 and the flexure mechanism 60, which comprises the two mechanical amplifiers 20-1, 20-2, form a group G. Preferably, the six length elements 15 and the six mechanical amplifiers 20 of the device 1 can be grouped into three such groups G, wherein the groups G, in particular their axis S, are each arranged at an angular distance of 120° from one another.

The deformation body 10, including the three flexure mechanisms 60, is thus also designed rotationally symmetrical with a rotation angle of 120°.

The movement of the material measure 25 can be detected by a scanning element 40. The scanning element 40 may be designed as an optical, capacitive, inductive or magnetic scanning sensor.

The device 1 comprises an evaluation unit 70 designed to evaluate the signals detected by the at least one scanning element 40 and to calculate therefrom the forces F and/or torques M acting between the two fastening elements. A 6-axis force-torque sensor can be formed by using six length elements 15 and six mechanical amplifiers 20. To this end, the signals detected by all six scanning elements 40 are fed to the evaluation unit 70, from which signals the forces Fx, Fy, Fz and torques Mx, My, Mz acting between the two fastening elements 11, 12 can be calculated with appropriate calibration.

The scanning element 40 and the evaluation unit 70 may be arranged on a printed circuit board 80 arranged in a recess 11a of the first fastening element 11, in particular, substantially parallel to the plane E1 of the first fastening element 11. The scanning element 40 is arranged in particular on the side of the printed circuit board 80 facing the second fastening element 12. The first fastening element 11 has, in particular, an opening 11b through which the scanning element 40 can look at the material measure 25 of the mechanical amplifier 20 (cf. FIGS. 8 and 9). A protected and compact arrangement can be made possible by arranging the circuit board 80 in the recess 11a of the first fastening element 11.

The deformation body 10 can be inserted into a pot-like housing 100 such that the first fastening element 11 is fixed in the housing 100, while the second fastening element 12 closes an opening of the pot-like housing 100. The housing 100 can provide both mechanical protection against damage or contamination as well as protection against foreign matter that could affect the measurement of the scanning element 40.

The device 1 can have at least one temperature sensor 90, preferably at least three temperature sensors 90, particularly preferably six or eight temperature sensors 90. The temperature sensors 90 are, in particular, distributed across the device 1, preferably evenly distributed. The evaluation unit 70 can pick up and evaluate the temperature signals from the temperature sensors 90, for example, to find an average temperature from all temperature signals. Advantageously, the evaluation unit 70 is designed to correct the forces F and/or torques M acting between the two fastening elements 11, 12 with respect to the temperature.

A force F acting on the deformation body 10 or a torque M acting on the deformation body leads, within the framework of the mechanical stiffness of the deformation body 10, to an elastic deformation of the deformation body 10, in particular of the length element 15 or length elements 15. Due to the mechanical coupling by means of the coupling element 30 between the deformation body 10 and the mechanical amplifiers 20 or the flexure mechanisms 60, a displacement is initiated at the input-side input 21 of the flexure mechanisms 60, which, taking into account the structure of the flexure mechanism 60, translates into a displacement of the output-side output 22 and thus leads to a movement of the material measure 25. In doing so, the coupling element 30, in particular, only picks up a portion of the force F acting on the deformation body 10 and/or the torque M acting on the deformation body 10, in particular, substantially transverse to the direction Z. The force flow is essentially guided through the deformation body 10, and the flexure mechanisms 60 are not involved in this. In the event the device 1 is overloaded, the deformation body 10 is essentially affected first, while all other components remain intact until the device 1 is completely compromised. The mechanical rigidity of the deformation body 10 can determine the general measuring range of the device 1, while the structure of the flexure mechanisms 60 can determine the sensitivity as well as the absolute displacements of the output-side outputs 22, wherein parasitic movements along or about the other spatial axes can be mostly avoided.

### LIST OF REFERENCE SIGNS

1 Device
10 Deformation body
11 First fastening element
11a Recess
11b Breakthrough
12 Second fastening element
15 Length element
15-1 Length element
15-2 Length element
15a First end
15b Second end
15c Bore
20 Mechanical amplifier
20-1 Mechanical amplifier
20-2 Mechanical amplifier
20c Bore
21 Input-side Input
21-1 Input-side Input
21-2 Input-side Input
22 Output-side output
22-1 Output-side output
22-2 Output-side output
25 Material measure
30 Coupling element
40 Scanning element
50 Flexure mechanism
60 Flexure mechanism
70 Evaluation unit
80 Printed circuit board
90 Temperature sensor
100 Housing
L Length
R Longitudinal direction
Z Direction
F Force
M Torque
E1 First plane
E2 Second plane
A Distance
α Angle
S Axis
G Group

1. A device (10) for measuring a force (F) and/or torque (M) with a deformation body (10) comprising a first fastening element (11), a second fastening element (12) arranged in a direction (Z) at a distance from the first fastening element (11) and at least one length element (15) arranged between the two fastening elements (11, 12) and comprising a first end (15a), a second end (15b) and a length (L) along a longitudinal direction (R), wherein a force (F) acting on the deformation body (10) or a torque (M) acting on the deformation body (10) leads to a deformation of the length element (15), characterized in that an input-side input (21) of a mechanical amplifier (20) is fastened to the deformation body (10) by means of a coupling element (30), wherein a material measure (25) is arranged on an output-side output (22) of the mechanical amplifier (20) and a deformation of the length element (15) leads to a movement of the material measure (25), wherein the movement of the material measure (25) can be detected by a scanning element (40), wherein the device (1) comprises an evaluation unit (70), which is designed to evaluate the signals detected by the at least one scanning element (40) and to calculate therefrom the forces (F) and/or torques (M) acting between the two fastening elements (11, 12).

2. The device according to claim 1, characterized in that the coupling element (30) picks up only a portion of the force (F) acting on the deformation body (10) and/or the torque (M) acting on the deformation body (10), in particular, substantially transverse to the direction (Z).

3. The device according to claim 1, characterized in that the coupling element (30) is detachably fastenable.

4. The device according to claim 1, characterized in that the coupling element (30) is designed as a screw, a clampable pin, a glued pin or an adhesive.

5. The device according to claim 1, characterized in that the mechanical amplifier (20) is designed as a flexure mechanism (50).

6. The device according to claim 5, characterized in that the flexure mechanism (50) is formed in one piece and has at least one flexure hinge, preferably a plurality of flexure hinges.

7. The device according claim 5, characterized in that the flexure mechanism (50) is made of metal, preferably aluminum or steel.

8. The device according to claim 1, characterized in that the first fastening element (11) is disc-like or disc-ring-like comprising a first plane (E1) and the second fastening element (12) disc-like or disc-ring-like comprising a second plane (E2), wherein the first plane (E1) and the second plane (E2) are arranged parallel to one another.

9. The device according to claim 1, characterized in that the longitudinal direction (R) of the length element (15) is arranged at an angle (α) between 5° and 85° relative to the direction (Z), preferably at an angle (α) between 10° and 80°, preferably at an angle (α) of 20° to 50°, particularly preferably at an angle (α) of approximately 35°.

10. The device according to claim 1, characterized in that a plurality of length elements, in particular six length elements (15), is arranged between the first fastening element (11) and the second fastening element (12).

11. The device according to claim 1, characterized in that two length elements (15-1, 15-2) are arranged between the first fastening element (11) and the second fastening element (12), wherein each length element (15-1, 15-2) is associated with a mechanical amplifier (20-1, 20-2), wherein the total of two mechanical amplifiers (20-1, 20-2) are realized by a single flexure mechanism (60) which has two input-side inputs (21-1, 21-2) and two output-side outputs (22-1, 22-2).

12. The device according to claim 11, characterized in that the two length elements (15-1, 15-2) are arranged mirror-symmetrical to an axis(S) which is arranged, in particular, perpendicular to the planes (E1, E2), and in that the flexure mechanism (60), which comprises the two mechanical amplifiers (20-1, 20-2) for said two length elements (15-1, 15-2), is designed mirror-symmetrical.

13. The device according to claim 11, characterized in that the two length elements (15-1, 15-2) and the one flexure mechanism (60) form a group (G), and three such groups (G) are arranged between the first fastening element (11) and the second fastening element (12), wherein the three groups (G) are, in particular, each arranged at an angular distance of 120° from one another.

14. The device according to claim 1, characterized in that the scanning element (40) and the evaluation unit (70) are arranged on a printed circuit board (80) which is arranged in a recess (11a) of the first fastening element (11), in particular, substantially parallel to the plane (E1) of the first fastening element (11).

15. The device according to claim 1, characterized in that the scanning element (40) is designed as an optical, capacitive, inductive or magnetic scanning sensor.

16. The device according to claim 1. characterized in that the device (1) has at least one temperature sensor (90), preferably at least three temperature sensors (90), particularly preferably six or eight temperature sensors (90).

17. The device according to claim 1, characterized in that the evaluation unit (70) is designed to carry out a correction of the forces (F) and/or torques (M) acting between the two fastening elements (11, 12) with regard to the temperature.
